(19) United States
(12) Patent Application Publication
(10) Pub. No.: US 2024/0250383 A1
(43) Pub. Date: Jul. 25, 2024

(54) Fast Charging Quasi-Solid State Li-Metal Batteries Enabled By Y-Alumina Separators

(71) Applicant: ARIZONA BOARD OF REGENTS ON BEHALF OF ARIZONA STATE UNIVERSITY, Scottsdale, AZ (US)

(72) Inventors: Jerry Lin, Scottsdale, AZ (US); Kishen Rafiz, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 18/562,463

(22) PCT Filed: May 17, 2022
(86) PCT No.: PCT/US2022/072360

§ 371 Date: Nov. 20, 2023

Related U.S. Application Data
(60) Provisional application No. 63/191,052, filed on May 20, 2021.

(51) Int. Cl. H01M 50/434; H01M 10/0525; H01M 10/42; H01M 50/403; H01M 50/491

(52) U.S. Cl. CPC H01M 50/434; H01M 10/0525; H01M 10/4235; H01M 50/403; H01M 50/491

(57) ABSTRACT

A lithium-metal battery electrode-supported separator includes an electrically conductive substrate and a separator coated on the substrate. The separator includes plate-shaped γ-alumina particles, and the γ-alumina particles define inter-particle tortuous pores. A method of making the electrode-supported separator includes preparing a slurry of the plate-shaped γ-alumina particles, spreading the slurry on an electrically conductive substrate to yield a coated separator, and drying the coated separator to yield the electrode-supported separator. A lithium-metal battery includes a first electrode, a separator coated on first electrode, a second electrode comprising lithium metal, and an electrolyte in contact with the first electrode and the second electrode. The separator includes plate-shaped γ-alumina particles, the γ-alumina particles define tortuous intra-particle pores, and the second electrode is in direct contact with the separator.

### CROSS-REFERENCE TO RELATED APPLICATION

This application claims the benefit of U.S. Provisional Application No. 63/191,052 entitled “FAST CHARGING QUASI-SOLID STATE LI-METAL BATTERIES ENABLED BY Y-ALUMINA SEPARATORS” and filed on May 20, 2021, which is incorporated herein by reference in its entirety.

### TECHNICAL FIELD

This invention relates to γ-alumina separators for lithium-metal batteries.

### BACKGROUND

Lithium metal batteries (LMBs) are rechargeable batteries with a metallic lithium anode. The anode is separated from the cathode by a porous separator, which allows passage of the electrolyte. LMBs can be thin and flexible, can deliver high energy, and can operate over a wide temperature range. These batteries are long-lasting and have a long shelf life.

FIG. 1 depicts lithium-ion battery (LIB) 100 with a liquid electrolyte. Lithium-ion battery 100 includes anode 102 and cathode 104. Anode 102 and cathode 104 are separated by separator 106. Anode 102 includes anode collector 108 and anode material 110 in contact with the anode collector. Cathode 104 includes cathode collector 112 and cathode material 114 in contact with the cathode collector. Electrolyte 116 is in contact with anode material 110 and cathode material 114. Anode collector 108 and cathode collector 112 are electrically coupled by closed external circuit 118. Anode material 110 and cathode material 114 are materials into which, and from which, lithium ions 120 can migrate. During insertion (or intercalation), lithium ions move into the electrode (anode or cathode) material. During extraction (or deintercalation), the reverse process, lithium ions move out of the electrode (anode or cathode) material. When a LIB is discharging, lithium ions are extracted from the anode material and inserted into the cathode material. When the cell is charging, lithium ions are extracted from the cathode material and inserted into the anode material. The arrows in FIG. 1 depict movement of lithium ions through separator 106 during charging and discharging.

### SUMMARY

This disclosure describes electrode-coated separators formed by blade coating plate-shaped γ-alumina particles on a nickel manganese cobalt oxide (NMC) cathode combined with liquid carbonate electrolytes to produce lithium-metal batteries. These plate-shaped particles are packed in a more compact manner than spherical γ-alumina particles. Thus, the tortuosity and hardness of the disclosed γ-alumina separator, enabled by the plate shaped-morphology of its particles, outperforms polypropylene (PP) and or spherical γ-alumina coated separators in terms of dendrite propagation induced battery failure at high charge and discharge C-rates. Stable performance of lithium-metal batteries with plate-shaped γ-alumina coated separators was seen up to 3 C-rate without the dendrite propagating through the separator. The plate-shaped γ-alumina coated separator battery can realize its full charge and discharge current, at the respective voltages up to about 75th cycle even at 3 C-rate. The disclosed γ-alumina separator provides a scalable and commercially viable option for use as a separator in lithium-metal battery systems, without causing dendrite propagation induced failure at high charge and discharge rates.

In addition to the embodiments of the attached claims and the embodiments described above, the following numbered embodiments are also innovative.

Embodiment 1 is a lithium-metal battery electrode-supported separator comprising: an electrically conductive substrate; and a separator coated on the substrate, wherein the separator comprises plate-shaped γ-alumina particles, and the γ-alumina particles define inter-particle tortuous pores.

Embodiment 2 is a separator of embodiment 1, wherein a thickness of the separator is in a range of 20 μm to 60 μm.

Embodiment 3 is a separator of embodiment 1 or 2, wherein an average thickness of the γ-alumina particles is in a range of 0.2 μm to 1 μm.

Embodiment 4 is a separator of embodiment 3, wherein the aspect ratio of the γ-alumina particles is in a range of 2 to 10.

Embodiment 5 is a separator of any one of embodiments 1 through 4, wherein a ratio of actual pathway length of the pores to a thickness of the separator is greater than 3.

Embodiment 6 is a separator of embodiment 5, wherein a radius of the inter-particle pores is in a range of 100 nm to 700 nm.

Embodiment 7 is a separator of embodiment 6, wherein the radius of the inter-particle pores is in a range of 200 nm to 600 nm.

Embodiment 8 is a separator of embodiment 7, wherein the radius of the inter-particle pores is in a range of 300 nm to 500 nm.

Embodiment 9 is a separator of any one of embodiments 1 through 8, wherein the substrate comprises nickel, manganese, and cobalt oxide.

Embodiment 10 is a method of making the electrode-supported separator of any one of embodiments 1 through 9, comprising:
preparing a slurry of the plate-shaped γ-alumina particles;
spreading the slurry on an electrically conductive substrate to yield a coated separator; and
drying the coated separator to yield the electrode-supported separator.

Embodiment 11 is a method of embodiment 10, wherein spreading the slurry on the electrically conductive substrate comprises spreading the slurry directly on the electrically conductive substrate.

Embodiment 12 is a lithium-metal battery comprising:
a first electrode;
a separator coated on first electrode, wherein the separator comprises plate-shaped γ-alumina particles and the γ-alumina particles define tortuous intra-particle pores;
a second electrode comprising lithium metal, wherein the second electrode is in direct contact with the separator; and
an electrolyte in contact with the first electrode and the second electrode.

Embodiment 13 is a battery of embodiment 12, wherein the first electrode is a nickel manganese cobalt oxide electrode.

Embodiment 14 is a battery of embodiment 12 or 13, wherein the electrolyte is a liquid electrolyte.

Embodiment 15 is a battery of any one of embodiments 12 through 14, wherein a thickness of the separator is in a range of 20 μm to 60 μm.

Embodiment 16 is a battery of any one of embodiments 12 through 15, wherein a tortuosity of the separator (EIS Method) is at least 6.

Embodiment 17 is a battery of any one of embodiments 12 through 16, wherein a porosity of the separator is in a range of 40% to 60%.

Embodiment 18 is a battery of any one of embodiments 12 through 17, wherein the separator demonstrates a lower solid electrolyte interface resistance than a similar separator comprising α-alumina particles.

Embodiment 19 is battery of any one of embodiments 12 through 18, wherein the separator demonstrates a lower charge transfer resistance than a similar separator comprising α-alumina particles.

Embodiment 20 is a battery of any one of embodiments 12 through 19, wherein the separator inhibits formation of lithium dendrites during charging and discharging of the battery.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic cross-sectional view a lithium-ion battery (LIB) with a liquid electrolyte.

FIG. 2 is a schematic cross-sectional view of an electrode-supported separator.

FIG. 3A is a top-view scanning electron microscopy (SEM) image of aluminum tri-hydrate (ATH) powder (˜2 μm particle size) as procured from R.J. Marshall Inc. FIG. 3B shows an x-ray diffraction (XRD) measurement of the aluminum tri-hydrate powder. FIG. 3C is a top-view SEM image of boehmite (˜2 μm particle size) formed post hydrothermal synthesis of the previously synthesized 40 wt. % ATH slurry. FIG. 3D shows an XRD measurement of the post hydrothermal synthesis formed boehmite.

FIG. 4A is an SEM image of synthesized γ-alumina. FIGS. 4B-4D show the particle size distribution, XRD measurement, and pore-size distribution, respectively, of the synthesized γ-alumina.

FIG. 5 is a cross-sectional SEM image of the γ-alumina separator on a nickel manganese cobalt oxide (NMC) cathode.

FIGS. 6A and 6B are cross-sectional SEM images of an electrode coated α-alumina separator pre-compression and post-compression, respectively. FIGS. 6C and 6D are cross-sectional SEM images of an electrode coated γ-alumina separator pre-compression and post-compression, respectively. The compression pressure applied during cell-crimping was 400 psi.

FIG. 7A shows constant current-constant voltage (CC-CV) charge-discharge curves at 0.2 C-rate for the NMC/Li cells with γ-alumina (dot-dash), α-alumina (dash), and PP separators (solid). FIG. 7B shows Nyquist plots obtained from electrochemical impedance spectroscopy (EIS) for the NMC/Li cells with α-alumina (circles), PP (squares), and γ-alumina (triangles) separators. The data were fit using EC-Lab® software (lines). The cells were made with NMC as cathode and lithium metal as anode.

FIGS. 8A and 8B show charge and discharge profiles representing voltage vs. time and current vs. time, respectively, for the lithium metal cell with γ-alumina separator at 1 C-rate.

FIGS. 8C and 8D show charge and discharge profiles representing voltage vs. time and current vs. time, respectively, for the lithium metal cell with γ-alumina separator at 2 C-rate.

FIGS. 9A-D are top-view SEM images at various magnifications of the surface of γ-alumina separator surface post 100 cycles at 2 C-rate.

FIGS. 10A and 10B show charge and discharge profiles for NMC/Li cell with γ-alumina separator at 3 C-rate for voltage vs. time and current vs. time, respectively.

FIGS. 11A and 11B show charge and discharge profiles representing voltage vs. time and current vs. time, respectively, for the NMC/Li cell with PP separator at 0.2 C-rate. FIGS. 11C and 11D show charge and discharge profiles representing voltage vs. time and current vs. time, respectively, for the NMC/Li cell with an α-alumina separator at 1 C-rate.

FIGS. 12A-12D are SEM images at various magnifications of the surface of PP separator surface post ˜15 cycles at 0.2 C-rate.

FIGS. 13A-13D are SEM images at various magnifications of the surface of PP separator surface post ˜20 cycles at 1 C-rate.

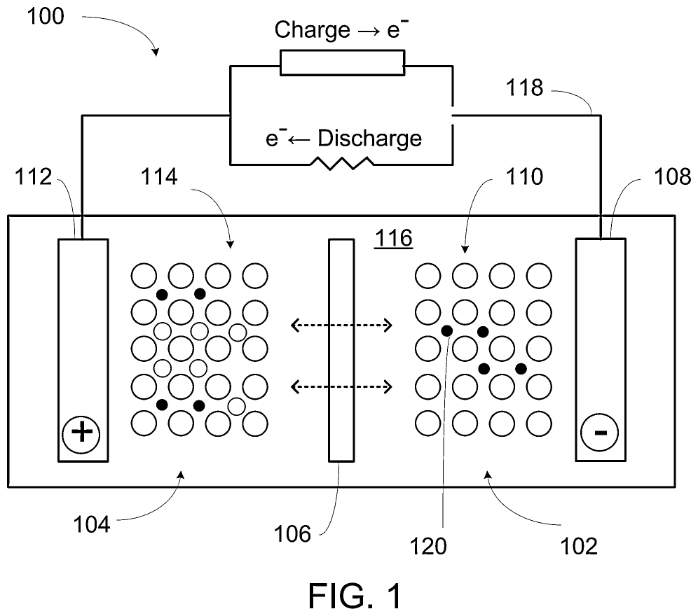

### DETAILED DESCRIPTION

This disclosure describes an electrode-supported separator that inhibits or prevents dendrite propagation for use in a lithium-metal battery. The separator includes an electrically conductive substrate and a separator coated on the substrate. The separator includes plate-shaped γ-alumina particles, and the γ-alumina particles define inter-particle tortuous pores. As used herein, “tortuous pores” generally refer to pores with a ratio of actual pathway length to a thickness of the separator of greater than 3. The thickness of the separator is typically in a range of 20 μm to 60 μm. An average thickness of the γ-alumina particles can be in a range of 0.2 μm to 1 μm. The aspect ratio of the γ-alumina particles is typically in a range of 2 to 10. A radius of the inter-particle pores is typically in a range of 100 nm to 700 nm (e.g., 200 nm to 600 nm or 300 nm to 500 nm). Suitable substrates include nickel, manganese, and cobalt oxide.

Fabricating the electrode-supported separator includes preparing a slurry of the plate-shaped γ-alumina particles, spreading the slurry on an electrically conductive substrate to yield a coated separator, and drying the coated separator to yield the electrode-supported separator. Spreading the slurry on the electrically conductive substrate can include spreading the slurry directly on the electrically conductive substrate.

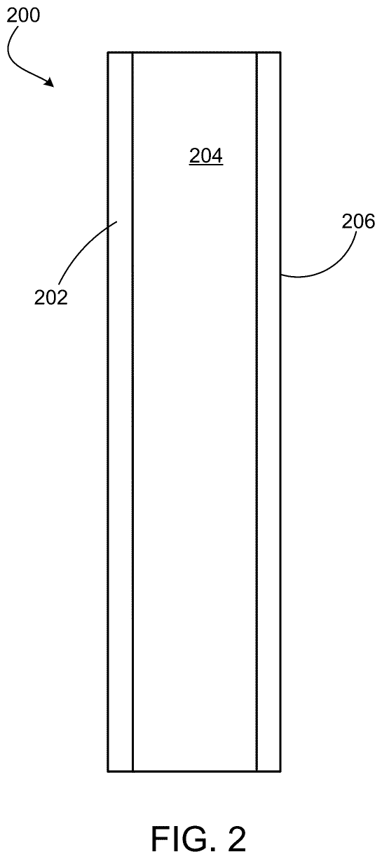

As described herein, a lithium-metal battery includes a first electrode, a separator coated on first electrode, a second electrode comprising lithium metal, and an electrolyte in contact with the first electrode and the second electrode. The separator includes plate-shaped γ-alumina particles and the γ-alumina particles define tortuous intra-particle pores. The second electrode can be in direct contact with the separator. In some examples, the first electrode is a nickel manganese cobalt oxide electrode. The electrolyte can be a liquid electrolyte. The separator typically has a thickness in a range of 20 μm to 60 μm, a tortuosity (electrochemical impedance spectroscopy method) of at least 6, and a porosity in a range of 40% to 60%. The separator demonstrates a lower solid electrolyte interface resistance than a similar separator comprising α-alumina particles. In some examples, the separator demonstrates a lower charge transfer resistance than a similar separator comprising α-alumina particles. The separator inhibits formation of lithium dendrites during charging and discharging of the battery. FIG. 2 depicts a cross-sectional view of electrode-coated γ-alumina separator 200. γ-alumina separator 202 has a uniform thickness in a range of about 20 μm to about 60 μm on the nickel manganese cobalt oxide (NMC) cathode 204, which has a thickness in a range of about 30 μm to about 100 μm (e.g., about 40 μm). The cathode is coated on a layer of aluminum foil 206. In one example, the γ-alumina separator has a thickness of approximately 25 μm and the NMC cathode has a thickness of approximately 40 μm.

### EXAMPLES

### Materials, Plate-Shaped γ-Alumina Synthesis, and Slurry Preparation

Plate-shaped γ-alumina was synthesized hydrothermally from aluminum tri-hydrate (˜2 μm particle size, R.J. Marshall Inc., USA). A 40 wt. % slurry of aluminum tri-hydrate (ATH) and de-ionized water were mixed and poured into a Teflon-lined autoclave. This solution was then heated in the autoclave at 220° C. for 3 hours to obtain bochmite particles of the required plate-shape of ˜2 μm size. After recovering the solution from the autoclave upon atmospheric cooling, the solution was dried on a hot plate while stirring to remove the bulk of the water in the solution.

The powder was then dried at 120° C. in vacuum to remove any traces of moisture in the bochmite powder. This was followed by calcination at 480° C. for 6 hours with atmospheric air as the medium to bring about the phase change from boehmite to γ-alumina without any change in particle size or morphology and to remove any trace moisture from the γ-alumina. To form the slurry of γ-alumina, 3 gm of powder with 1 gm of 5 wt. % polyvinyl alcohol (PVA) aqueous solution (molecular weight: 77000-79000 Da) (ICN Biomedical Inc., USA) and 1 gm de-ionized water was mixed until a homogenous slurry with no air bubbles was formed.

α-alumina (particle size ˜2.2 μm) was obtained from Aluchem Inc., USA., and an aqueous α-alumina slurry was prepared by mixing 3 gm of powder with 1 gm of 5 wt. % polyvinyl alcohol (PVA) aqueous solution (molecular weight: 77000-79000 Da) (ICN Biomedical Inc., USA) and 1 gm de-ionized water. The commercially used PP-2500 separator of 25 μm thickness was procured from Celgard LLC, USA, for use as a control. Lithium-metal chips of 0.1 mm thickness and 15.6 mm diameter and NMC electrodes were procured from MTI Corporation, USA. The components for constructing the CR-2032 cell were procured from X2 Labwares, Singapore. The electrolyte used was 1M LiPF₆ salt in equal volume of ethyl carbonate (EC), diethyl carbonate (DEC) and dimethyl carbonate (DMC); EC:DEC:DMC=1:1:1, v/v/v) procured in a sealed container from MTI, USA.

### Coating of Separator and Characterization

The prepared slurry of γ-alumina and α-alumina was dropped across one of the edges and then spread down the length of the aluminum foil or electrode using a caliper-adjustable doctor blade (Gardco LLC, USA). For producing the metal-oxide coated electrode-supported separators the initial blade gap was kept at 50 μm. The coated separator was dried in a humidity controlled chamber at 40° ° C. and 60% relative humidity for 8 hours. The separator was then dried using a temperature controlled vacuum oven at 70° C. (Thermo Fisher Scientific, USA) for 12 hours to completely remove all traces of moisture. The thickness of the coated separator was measured by a micrometer (Mitutoyo, Japan) with an accuracy of 1 μm. The final thickness was found to be 40 μm for both the separators, as about 10 μm compression was observed due to the drying of the separator.

To measure the porosity of the inorganic γ-alumina and α-alumina separators, the coated-separators on the aluminum foil were peeled off carefully without causing any physical damage to the separator. These free-standing γ-alumina and α-alumina separators were obtained to match the physical free standing nature of PP-2500 separator. The porosity (Ø) of the separator was obtained from the measured bulk density (using the weight and dimensional volume of the coated silica and silicalite membrane separator) using Eq. 1.

$$∅ = 1 - \frac{{ρ}_{bulk}}{{ρ}_{particle}} \qquad ( 1 )$$

The tortuosity of the PP-2500, α-alumina and γ-alumina separators were measured by soaking the separators in the electrolyte for 24 hours inside the glovebox. Post this step, the soaked separator was inserted between two stainless steel electrode plates which had the same shape and cross-section as the free standing separator. The ohmic resistance of the separator was then obtained by using the electrochemical impedance spectroscopy (PARSTAT 2263 EIS station, Princeton Applied Research, USA) at 25° C. The scanning parameters were set to a starting frequency of 100 kHz and end frequency of 100 mHz, with an AC amplitude of 10 mV rms. The tortuosity (T) of the separator is related to its measured ohmic resistance (R) and the conductivity of the electrolyte “K” by the following equation

$$τ = \frac{R \times A \times K \times ∅}{d} \qquad ( 2 )$$

where “d” is the thickness of the separator, “A” is the cross-sectional area of the separator and “Ø” is the porosity of the separator. Thus, Eq. 2 was used to find the tortuosity of the various separators soaked with the electrolyte.

The cross-sectional morphology of the coated separator was examined by scanning electronic microscopy (SEM) (Philips, USA, FEI XL-30) of separator samples sputter-coated with gold to facilitate the development of the micrographs. Also, the γ-alumina particles synthesized via the hydrothermal route were characterized for particle size by performing a top-view SEM post coating on aluminum foil using the blade-coating method. The top-view SEM images were quantified for particle size distribution using Gatan GMS software for particle size distribution with the particle size interval being 0.25 μm. Energy dispersive x-ray spectroscopy (EDX) extension was used on the same SEM equipment to obtain elemental maps.

X-ray diffraction patterns were obtained (Bruker AXS-D8, Cu Kα radiation, USA) on NMC coated with γ-alumina to confirm the phase structure of the coated material. The coated aluminum foils were cut into 16 mm disks and tested for their pore size distribution using a mercury porosimeter (Micrometrics Auto Pore V, USA). This characterization was done by coating the γ-alumina and α-alumina powder on aluminum foil and not NMC so that the pore size distribution of the NMC does not interfere with the measurement of the pore size distribution of the respective powders. The mercury porosimetry was done at both high-pressure mode and low-pressure mode to detect pore sizes ranging from the nanometer to micrometer dimensions.

### Construction and Testing of Coin-Cell Followed by Separator Examination

Disks of α-alumina or γ-alumina coated electrode of 16 mm diameter were cut from the corresponding coated electrode sheets and then kept in the vacuum oven at 70° C. for 12 hours. This disk was then immediately taken inside an argon-filled glovebox (Innovative Technology Inc., USA) and kept in it for a period of 24 hours to remove any traces of atmospheric gases or moisture in the electrode-supported separator disks. The other components of the cell were already kept for assembly in the glovebox. The cut 16 mm electrode-supported separator disk was placed inside the bottom case of the CR-2032 cell and 150 μl of electrolyte (1M LiPF₆ salt in equal volumes of ethyl carbonate (EC), diethyl carbonate (DEC) and dimethyl carbonate (DMC); EC:DEC:DMC=1:1:1, v/v/v) was pipetted onto the surface of the top facing α-alumina/γ-alumina coated surface of the NMC electrode.

A lithium metal chip (MTI, USA) of 0.1 mm thickness and 15.6 mm diameter was then very carefully placed on top of the separator surface, so as to not damage the separator. Two spacers and one spring (X2 Labwares, Singapore) were then placed on the graphite anode followed by the placement of the top case of the CR-2032 cell to closely envelop the full-cell. The coin-cell was then crimped to a pressure of 400 psi. To examine the morphology of the α-alumina and γ-alumina coated-separators post crimping, these coated-separators were crimped in the same coin-cell without the addition of the electrolyte and then the cell was de-crimped. These crimped separators were sputter coated with gold and examined for their cross-section using SEM. Moreover, to examine the propagation of dendrites through the separator, the cycled and short coin-cells with α-alumina, γ-alumina and PP separators, were disassembled inside the glovebox. The lithium metal anode was removed from the cell and the separator coated cathodes and the cycled PP separator were placed on a SEM sample holder stage. These sampler holders were then taken for gold sputtering inside a vacuum sealed container and then examined for dendrites on the surface of the separator which was in contact with the anode.

The assembled lithium-metal coin-cell filled with the electrolyte was then taken out and its charge and discharge characteristics were tested by a battery testing system (Neware Co., China). To test the performance of the various separators at varying C-rates (from 0.2 C-rate to 3 C-rate), the cells with PP, α-alumina and γ-alumina separators were tested at various C-rates between 2.0 to 4.2 volts for 100 cycles, with the standard CC-CV (constant current-constant voltage) method. Electrochemical impedance spectroscopy (EIS) measurements of the assembled cells were conducted using PARSTAT 2263 EIS station (Princeton Applied Research, USA) in the AC mode. Nyquist plots for the assembled full cells were generated by utilizing a frequency range of 100 kHz to 100 mHz.

### Formation of γ-Alumina Powder, γ-Alumina Separator and its Characterization

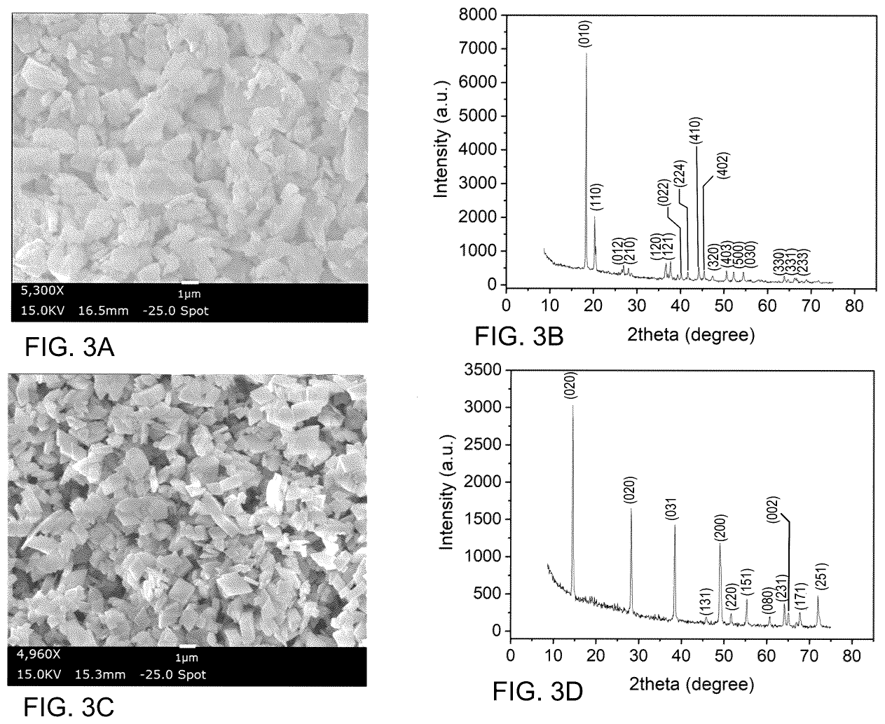

FIGS. 3A and 3B respectively show the top-view SEM and XRD of the procured ATH powder. The particle size of the ATH particles matches with the vendor described average particle size of 2 μm. Also, the XRD pattern confirms that the powder is actually in the gibbsite state, which is as per the requirement of the synthesis procedure. This powder was used to make the 40 wt. % slurry of aluminum tri-hydrate and de-ionized water. The resultant slurry was used for the synthesis of bochmite, to convert these rounded particles of ATH to plate shaped particles. FIGS. 3C and 3D respectively show the top-view SEM and XRD of bochmite which is formed post hydrothermal synthesis of the 40 wt. % ATH slurry. The SEM image shows that the particle size does not change significantly, but the shape of the particle changes from rounded to plate-shaped. This occurs due to the phase change from gibbsite to bochmite during the hydrothermal synthesis. The XRD pattern confirms the crystal structure to be of the bochmite phase. This bochmite powder was calcined to remove the excess water from the crystal and to form γ-alumina, without changing the particle size during the calcination process.

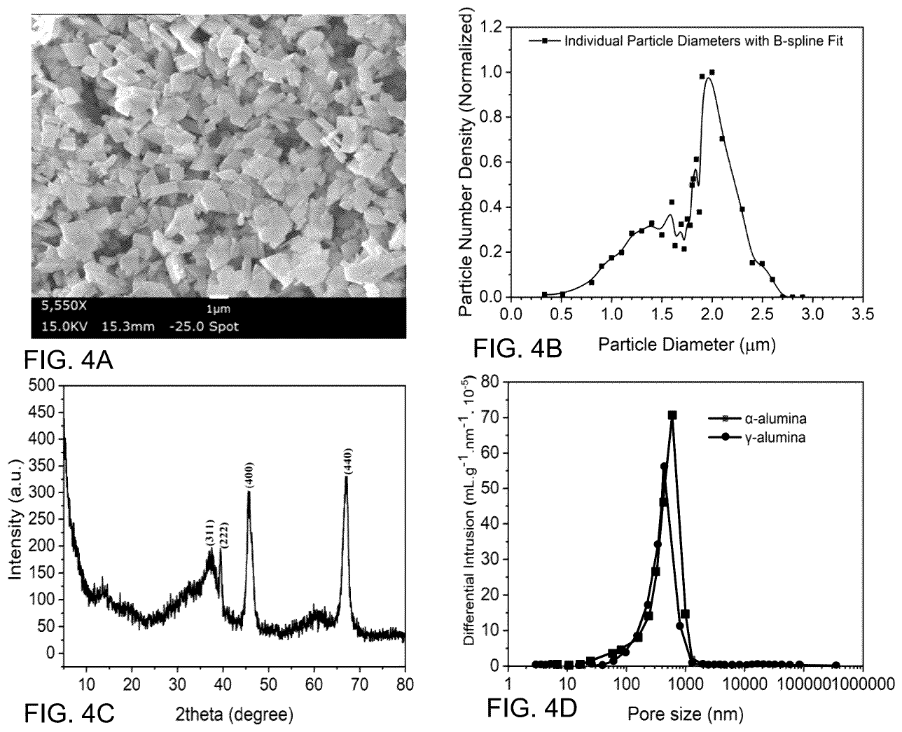

The particle size analysis of the synthesized γ-alumina particles was done from the SEM images, by processing the images such as FIG. 4A using Gatan particle size measurement software (GMS-90) to produce the particle-size distribution histogram shown in FIG. 4B. The particles are of 2-dimensional plate shape with a high length to thickness aspect ratio of around 7 (length, width and thickness about 2 μm, 1.5 μm and 300 nm respectively). Thus, these particles can be defined as rectangular cuboid plate-shaped particles where the average particle size is approximately 2 μm along the length, which is close to the pore size of the NMC cathode. This particle size helps in the better adhesion of the separator to the cathode while blade coating.

The γ-alumina powder was coated on aluminum foil and examined by XRD as shown in FIG. 4C, confirming that the synthesized powder is γ-alumina. The separator films of γ-alumina and α-alumina coated on aluminum foil were subjected to mercury porosimetry and the pore-size distribution results are shown in FIG. 4D. The pore-size distributions of the γ-alumina and α-alumina films are very similar. The γ-alumina film has a pore-size of around 430 nm while the α-alumina film has a pore size of around 610 nm. This is a design parameter while selecting the particle sizes for these separators, as we want to compare how the tortuosity of the pores in these films are responsible for preventing the propagation of dendrites. Thus, only the tortuosity due to the different particle morphologies was changed, keeping the pore sizes as close as possible.

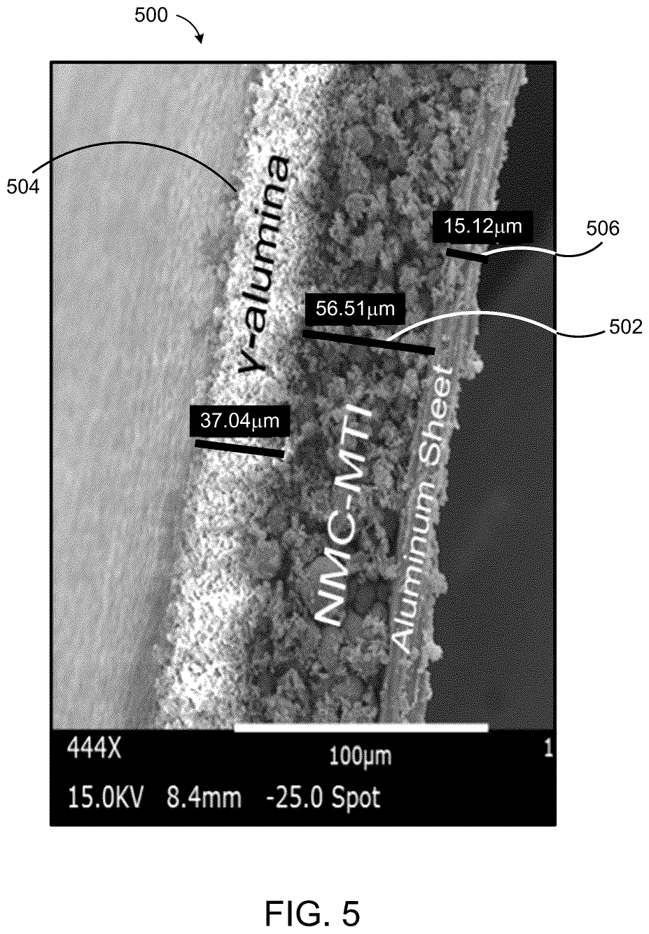

The characterized powder was then made into a slurry and blade-coated onto the NMC cathode material to form an electrode-coated γ-alumina separator. FIG. 5 is a cross-section SEM image of the separator. The formed electrode-coated γ-alumina separator 500 is uniform in thickness across the electrode 502 with a thickness of ˜40 μm, as compared to the 25 μm thick separator 504. This is the minimum thickness that could be achieved with a single coating without the formation of any cracks or non-homogeneities, so that the isolation of the electrodes may be achieved without a substantial increase in the resistance. EDX spectroscopy confirmed that the regions of the separator, cathode and the aluminum foil 506 on which the cathode 502 is coated are distinguishable and not damaged during the coating process.

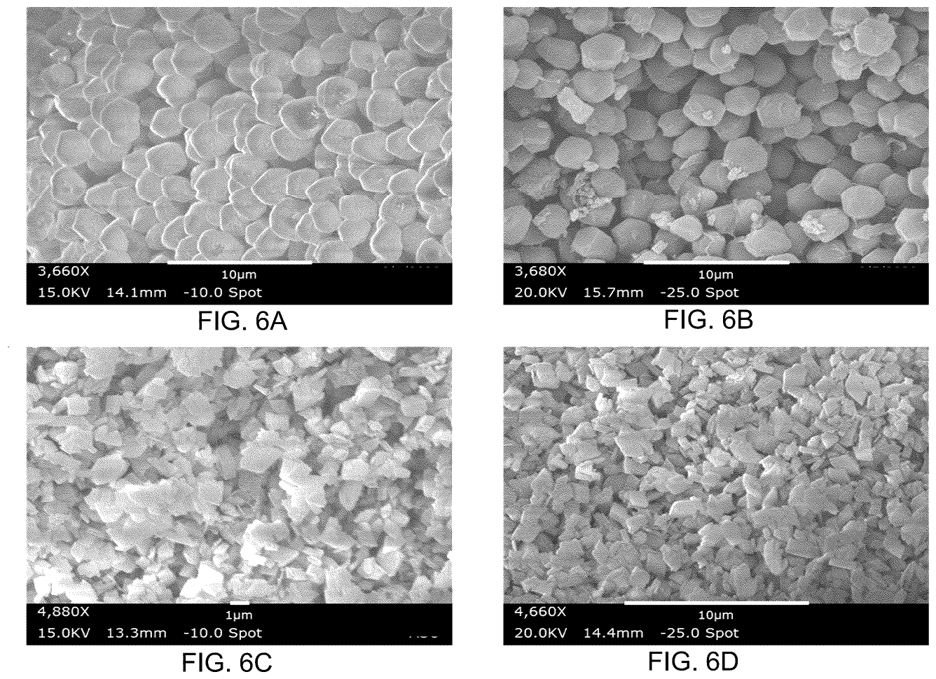

FIGS. 6A and 6B are the cross-sectional SEM images of the α-alumina separator coated on the NMC electrode, pre and post cell-crimping compression to a pressure of 400 Psi, respectively. The particle size of the α-alumina powder was selected to be around 2 μm, which would result in a pore size of around 600 nm. This closely matches the 400 nm pore size of the γ-alumina separator, which allows for the comparison of the effect of tortuosity of pores with approximately the same pore diameter. The images show that there is no significant change in the packing of particles and the resulting tortuosity does not get affected due to the applied pressure of crimping during the cell construction. This is expected as the spherical nature of these α-alumina particles would resist a tighter packing due to an even distribution of the compression force applied during crimping.

FIGS. 6C and 6D are the cross-sectional images of the γ-alumina separators coated on the NMC electrode, pre and post cell crimping compression to a pressure of 400 Psi, respectively. The images show that the packing of the γ-alumina particles becomes tighter post the compression on crimping at 400 Psi. This is expected as the non-uniform particle morphology allows for the pore spaces to get reduced in dimension when the compression stress is applied on the separator during crimping. Thus, a tortuous separator results due to the plate-shaped particles of γ-alumina when the separator is coated on the electrode. Furthermore, when the cell is crimped during its construction, an even more tortuous separator is formed due the higher packing density of the plate shaped particles.

The porosity, pore size and pore tortuosity of the separator are parameters which can determine how effectively the propagation of dendrites will be suppressed by the separator. The values of these properties of the γ-alumina, α-alumina and PP separators have been quantified using the respectively mentioned procedures in the experimental section, with the final tortuosity value having an ˜6% error. As seen from the values in Table 1, the pore diameter of the γ-alumina and α-alumina separators are quite similar, but the tortuosity of the former is more than 3 times the latter. Moreover, the porosity of the γ-alumina separator is lower than that of the α-alumina separator. Both these observations are in accordance with the morphology of the separator particles and the resulting packing. In the case of α-alumina separator, the spherical particles are packed more loosely resulting in a higher porosity, while the plate shaped γ-alumina particles are more tightly packed, and thus have a lower porosity. This packing also results in a higher tortuosity of the γ-alumina separator. These higher tortuosity and lower porosity values contributes to suppression of the dendrite propagation at higher C-rates for the γ-alumina separator.

TABLE 1
Quantified values of various separator physical characteristics
and the resulting tortuosity due to specific morphology
of the separator particles

| | | Particle | Pore | | Tortuosity |
|---|---|---|---|---|---|
| | Thickness | Diameter | Radius | Porosity | (EIS |
| Separator | (μm) | (μm) | (nm) | (%) | Method) |
| PP | 25 | N/A | 65 | 39 | 2.32 |
| α-alumina | 40 | 2.2 | ~610 | 66 | 2.95 |
| γ-alumina | 40 | 2.0 | ~430 | 54 | 6.95 |

### Separator Performance Evaluation

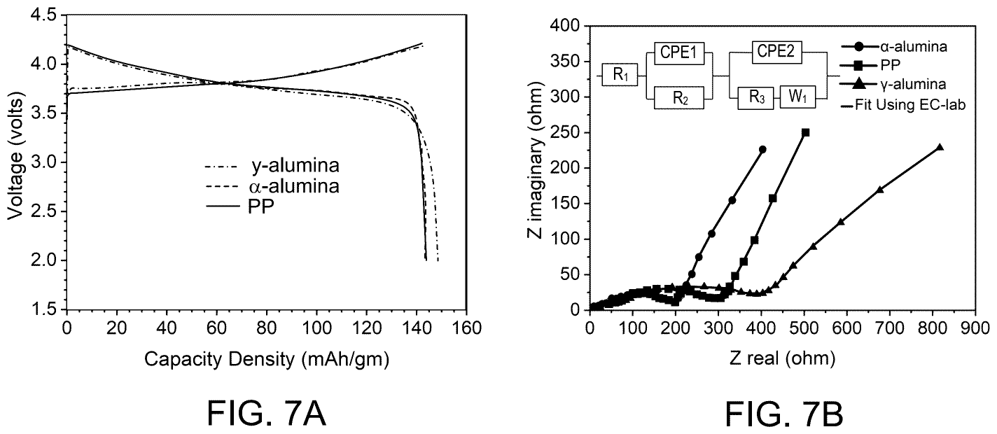

FIG. 7A shows 1^{st} cycle of the constant current-constant voltage (CC-CV) charge-discharge curve of the NMC/Li cell with γ-alumina separator at 0.2 C-rate in comparison with the NMC/Li cells with α-alumina and PP separators respectively. All three cells show similar charging and discharging curves characteristic of the NMC/Li cells. The Nyquist plots and corresponding equivalent circuit for these NMC/Li cells with three separators are also given in FIG. 7B. The quantitative values for resistance of the cells with various separators are quantified in Table 2. As shown, the resistance offered by the α-alumina separator is lesser than the PP separator even though it is thicker than the latter. This can be explained by the much higher wettability and porosity of the α-alumina separator towards the electrolyte, which results in lower resistances. However, γ-alumina separator exhibits highest ohmic resistance, mainly due to high tortuosity, as well as higher SEI and charge transfer resistance consistent with its less sharp discharge CC-CV curve for the cell with γ-alumina shown in FIG. 7A.

TABLE 2
Values of resistances as extracted from the fitted
Nyquist plots using EC-lab software for NMC/Li-metal
cells with PP, α-alumina and γ-alumina separators

| | Equivalent | | | |
|---|---|---|---|---|
| | resistance | | | |
| Resistance in | from Zfit in | PP | α-alumina | γ-alumina |
| Circuit | EC-lab | (ohm/cm²) | (ohm/cm²) | (ohm/cm²) |
| R₁ | R_{ohmic} | 3.14 | 2.54 | 6.85 |
| R₂ | R_{SEI} | 179 | 147 | 239 |
| R₃ | R_{charge-transfer} | 301 | 206 | 392 |

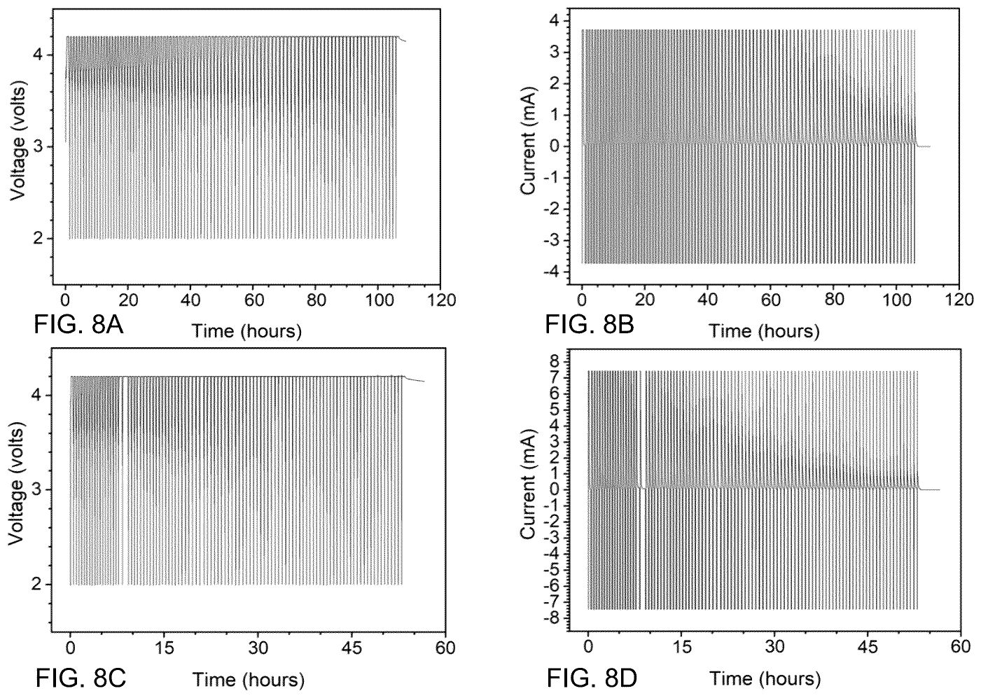

FIGS. 8A and 8C show the voltage vs. time curves for the γ-alumina separator cell at 1 C-rate and 2 C-rate respectively, while FIGS. 8B and 8D show the current vs. time curves for the γ-alumina separator cell at 1 C-rate and 2 C-rate respectively. As seen from FIGS. 8A and 8C, the voltage vs. time curves of the cell with γ-alumina separator do not show any appreciable variation during the charging and discharging of the lithium metal battery at 1C and 2C rates for 100 cycles. The stable voltage profiles mean that the formed dendrites of the lithium metal are retained on its surface due to them having no path to move/propagate forward, even at higher rates of charging and discharging. Moreover, as seen from FIGS. 8B and 8D, the stable current vs. time curves denote that there is no inactive lithium metal trapped in the separator which leads to the loss of the amount of current which can be successively discharged from the cell at the respective C-rate. The previously quantified values of tortuosity and porosity (as compared to α-alumina) determine that the γ-alumina separator would prevent the propagation of dendrites at high C-rates, due to its high value of tortuosity and low value of porosity. Even when the C-rate is high, the dendrite would not have enough propensity to move through the tortuous pathway of the pore.

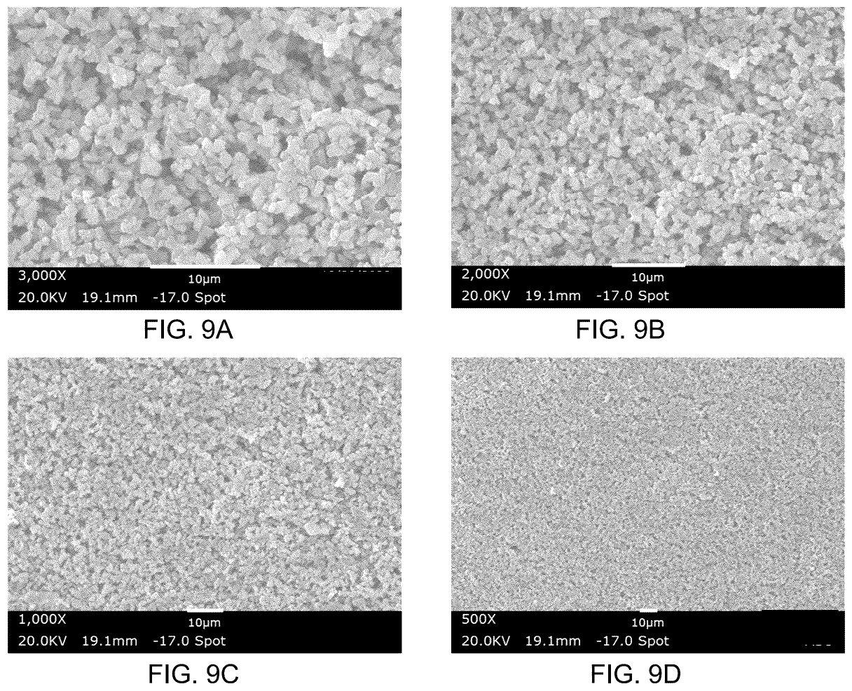

FIGS. 9A-9D are SEM images of the surface of the post-cycled γ-alumina separator which was in contact with the lithium metal anode while cycling at 2 C-rate. This electrode-coated separator while still in contact with the electrode, was carefully recovered from the disassembled cell inside the glovebox without rubbing or pressing it against the lithium metal. This was done to prevent damage to the residual lithium metal that would be on the surface of the separator, in case the lithium metal dendrites had propagated through the separator. FIGS. 9A-9D were taken both at low and high magnifications in order to observe residual lithium metal that would have been lodged into the pores while propagating through the separator. The lower magnification images, FIGS. 9C and 9D, show that the lithium metal residues are not present on the surface of the separator on a larger area. Whereas the higher magnification images, FIGS. 9A and 9B, show that the lithium metal residues are absent even on a micro-scale of the pore areas.

When the image FIG. 6D is compared with image FIG. 9A, which are respectively the images of the separator pre and post cycling with the lithium metal anode at similar magnification, the separator particles and pore areas are observed to be very similar in appearance. If the dendrites would have penetrated through the separator, then there would have been remnants of the lithium metal at the interface of the separator and the lithium metal anode. However, no such remnants of the lithium metal at these pores at the above mentioned C-rate of cycling were seen. Thus, the dendrites have been prevented from moving into the separator surface and remain attached to the lithium metal anode. It can be concluded that the separator pores and surface have not been penetrated with lithium dendrites.

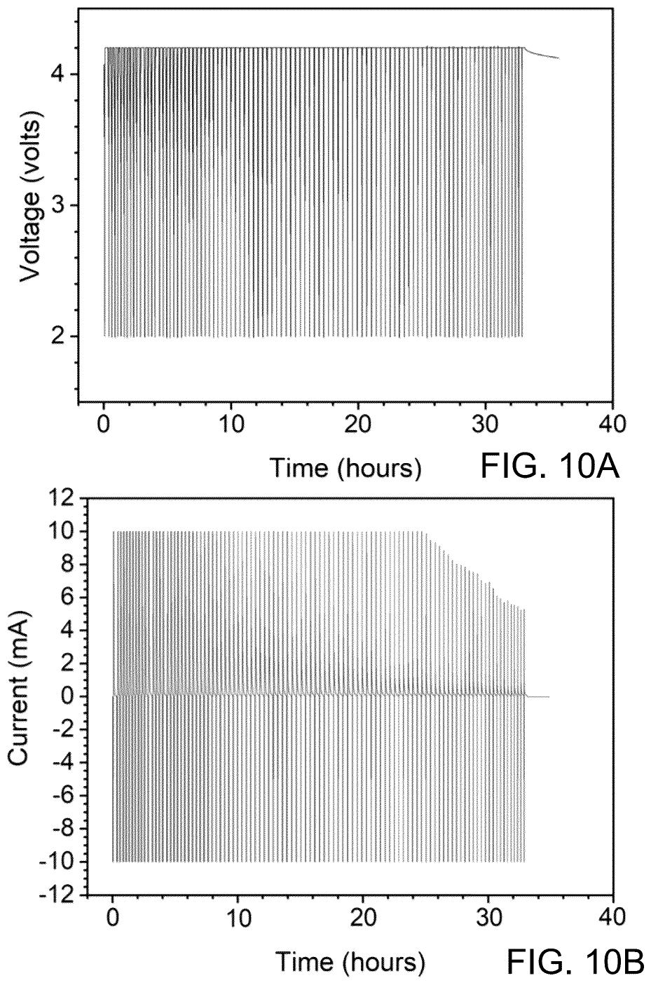

FIGS. 10A-10B show that on successively increasing the charge and discharge rate to 3C-rate, there is a decrease in the charge current around the 75th cycle. This can be seen by the respectively lower charge current peaks in FIG. 10B. This charge current decrease is an indication of the dendrite moving into the matrix of the separator which leads to the loss of electrochemically active lithium of the anode. This loss of electrochemically active lithium prevents the cell from realizing the full charge capacity and as the lithium lodged in the separator matrix no longer takes part in the electrochemical charge and discharge reactions.

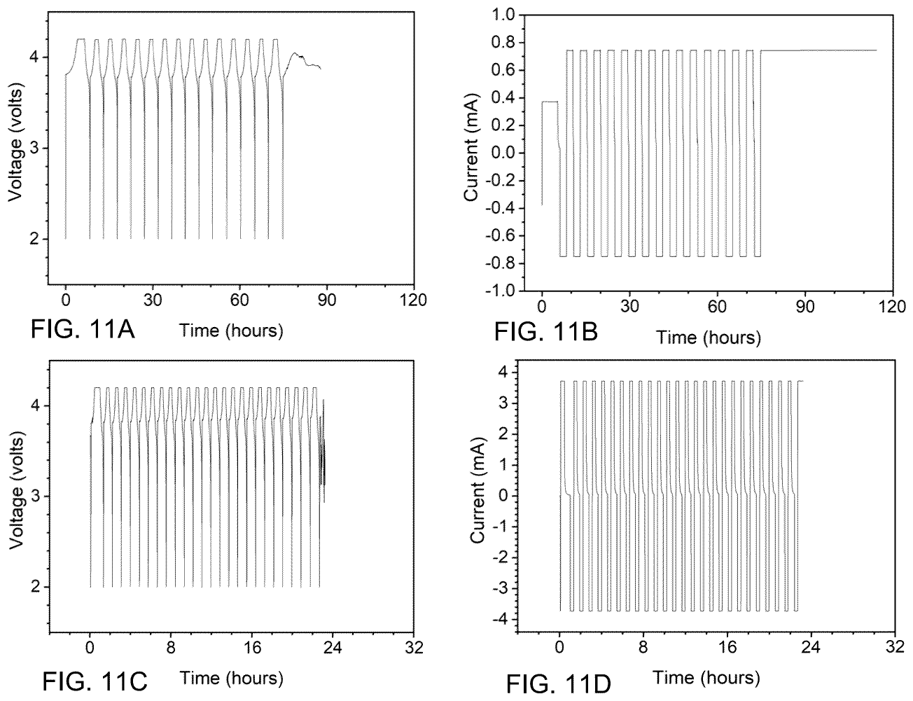

The sudden drop in voltage is a characteristic of the dendrite propagation through the separator. This sudden voltage drop is caused at least in part by the short-circuiting of the cell when the dendrite propagates through the separator and reaches the cathode. In FIGS. 11A and 11C, the voltage is seen to drop for the PP and α-alumina separator cells at 0.2 C-rate and 1 C-rate respectively. Also, as seen from FIGS. 11B and 11D, when the cell is short-circuited the system tries to increase the current to its maximum allowed value to try to charge the cell, but the current just passes through the cell and does not increase the cell voltage any further. The α-alumina and PP separators due to their lower tortuosity as compared to the γ-alumina separator are unable to prevent the propagation of dendrites at higher C-rates. As seen from FIGS. 11A and 11B, the PP separator due to its lowest tortuosity and inherently lowest material hardness allows the propagation (piercing of the separator by the lithium dendrite) at 0.2 C-rate after ˜15 charge-discharge cycles.

The α-alumina separator fares better and is able to prevent the propagation of dendrites through the separator up to ˜20 cycles at 1C-rate. The comparatively lower dendrite suppression of the α-alumina separator as compared to the γ-alumina separator, even though they have a similar hardness, shows the role of particle shape for a more dendrite passivating separator. The relatively higher porosity and low tortuosity of the α-alumina separator reduces its dendrite suppression characteristics and a higher pore volume allows for easier dendrite mobility.

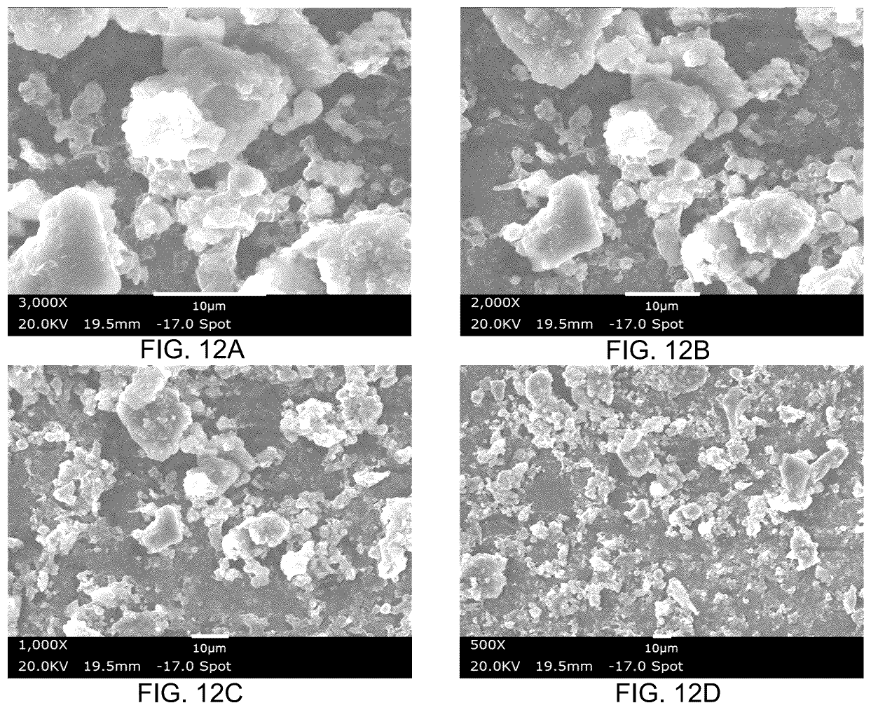

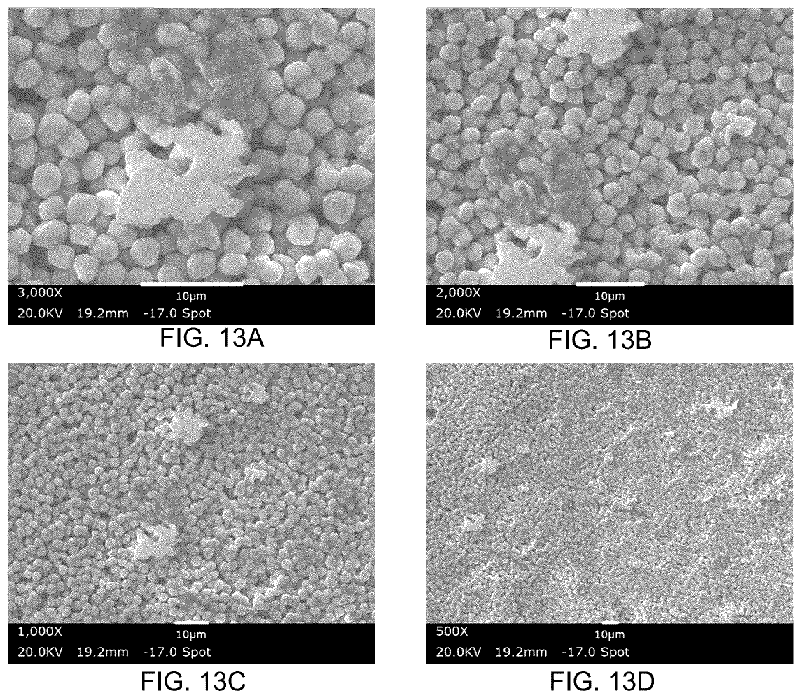

FIGS. 12A-12D and 13A-13D show surfaces of PP separator and α-alumina separator recovered from the cells after cycling and failing at 0.2 C-rate. The various magnifications at which these images were taken show the detailed local area as well as a macro view of the larger separator surface. When compared to FIGS. 6A and 6B which represents the pristine α-alumina and PP separator, these randomly shaped white particles are seen are foreign entities in FIGS. 12A-12D and 13A-13D. The SEM images in FIGS. 12A-12D and 13A-13D are of the surface facing the lithium metal anode and thus the dendrites which propagate into the separator would have initially gone through this surface facing the lithium metal. From the SEM images in FIGS. 12A-12D, it is seen that there are several dendrites that would have pierced through the PP separator even while cycling at such a low C-rate. This can be attributed to its low material strength and low tortuosity. Similarly, in FIGS. 13A-13D some dendrites which would have propagated through the α-alumina separator would have left their remnants as observed as the white foreign particles on the surface of the α-alumina separator.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A lithium-metal battery electrode-supported separator comprising:
an electrically conductive substrate; and
a separator coated on the substrate, wherein the separator comprises plate-shaped γ-alumina particles, and the γ-alumina particles define inter-particle tortuous pores.

2. The separator of claim 1, wherein a thickness of the separator is in a range of 20 μm to 60 μm.

3. The separator of claim 1, wherein an average thickness of the γ-alumina particles is in a range of 0.2 μm to 1 μm.

4. The separator of claim 3, wherein the aspect ratio of the γ-alumina particles is in a range of 2 to 10.

5. The separator of claim 1, wherein a ratio of actual pathway length of the pores to a thickness of the separator is greater than 3.

6. The separator of claim 5, wherein a radius of the inter-particle pores is in a range of 100 nm to 700 nm.

7. The separator of claim 6, wherein the radius of the inter-particle pores is in a range of 200 nm to 600 nm.

8. The separator of claim 7, wherein the radius of the inter-particle pores is in a range of 300 nm to 500 nm.

9. The separator of claim 1, wherein the substrate comprises nickel, manganese, and cobalt oxide.

10. A method of making the electrode-supported separator of claim 1, comprising:
preparing a slurry of the plate-shaped γ-alumina particles;
spreading the slurry on an electrically conductive substrate to yield a coated separator; and
drying the coated separator to yield the electrode-supported separator.

11. The method of claim 10, wherein spreading the slurry on the electrically conductive substrate comprises spreading the slurry directly on the electrically conductive substrate.

12. A lithium-metal battery comprising:
a first electrode;
a separator coated on first electrode, wherein the separator comprises plate-shaped γ-alumina particles and the γ-alumina particles define tortuous intra-particle pores;
a second electrode comprising lithium metal, wherein the second electrode is in direct contact with the separator; and
an electrolyte in contact with the first electrode and the second electrode.

13. The battery of claim 12, wherein the first electrode is a nickel manganese cobalt oxide electrode.

14. The battery of claim 12, wherein the electrolyte is a liquid electrolyte.

15. The battery of claim 12, wherein a thickness of the separator is in a range of 20 μm to 60 μm.

16. The battery of claim 12, wherein a tortuosity of the separator (EIS Method) is at least 6.

17. The battery of claim 12, wherein a porosity of the separator is in a range of 40% to 60%.

18. The battery of claim 12, wherein the separator demonstrates a lower solid electrolyte interface resistance than a similar separator comprising α-alumina particles.

19. The battery of claim 12, wherein the separator demonstrates a lower charge transfer resistance than a similar separator comprising α-alumina particles.

20. The battery of claim 12, wherein the separator inhibits formation of lithium dendrites during charging and discharging of the battery.
